(19) United States
(12) Patent Application Publication
(10) Pub. No.: US 2003/0183767 A1
(43) Pub. Date: Oct. 2, 2003

(54) System for counting living beings

(76) Inventors: Gilbert Bruno Meunier, Peronne en Melantois (FR); Paul Fernand Jean-Pierre Deparis, Bacqueville en Caux (FR)

Correspondence Address: YOUNG & THOMPSON, 745 SOUTH 23RD STREET 2ND FLOOR, ARLINGTON, VA, 22202

(21) Appl. No.: 10/276,558

(22) PCT Filed: Apr. 5, 2001
(86) PCT No.: PCT/FR01/01024

(30) Foreign Application Priority Data
May 18, 2000 (FR) 00 06346

(51) Int. Cl. G01J 5/02

(52) U.S. Cl. 250/353; 250/342

(57) ABSTRACT

A system for counting living beings moving on a first surface (0) and passing through a second cylindrical surface with substantially vertical generatrix, consists of N thermal radiating detection cells (11) having in particular a thermopile (30) including at least a sensitive element (31), and elements focusing (34) the thermal radiation and generating a field of vision (111) extended along a direction, the N detection cells (11) being distributed between two curves, one of the curves coinciding with the base line of the cylindrical surface crossed by the living beings, and the other curve being distant from the former one by a length D (42) equal to 5 cm at least, the direction of the extension of the field of vision of each cell being substantially tangent to one of the two curves.

The subject of the invention is a system for counting living beings moving on a first surface and passing through a second cylindrical surface with a substantially vertical generatrix. Such a system consists of a set of N thermal radiation detection cells and an electronic device for acquiring and processing signals delivered by these cells.

Many systems for counting living beings are known based on the detection of thermal radiation.

International application WO 9210812 describes such a counting system, using a single cell which has a sensor and a lens positioned in front thereof. This sensor consists of two rows of pyroelectric detectors. The lens focuses the thermal radiation on each of the detectors. This type of thermal radiation detector only allows the detection of relatively fast temperature variations in the field of vision. The cell creates two parallel monitoring planes formed by the axes of the beams associated with the detectors. After acquiring the electrical signals delivered by the detectors, a processing unit evaluates the number of living beings crossing the two planes and their direction of movement. This device is suitable for counting in passages of low height and of low width, for example a bus door. This device is virtually unusable in passages with a large width given the divergence of the field of vision of the sensor. Furthermore, the use of pyroelectric detectors provided for within the scope of this international application makes it difficult to detect slowly moving living beings.

U.S. Pat. No. 4,799,243 describes another system for counting moving living beings. This system consists of cells, each cell comprising two thermal radiation detectors and a lens. For each cell, these two detectors create two separate fields of vision, which are substantially symmetrical with respect to the vertical. The arrangement of the cells, as provided for in this patent, is chosen to cover the entire width of the passage to be monitored with an overlap of the fields of vision in a direction perpendicular to the crossing direction and a separation of the fields of vision in the crossing direction. Such an arrangement does not allow living beings who are too close to each other to be counted in the crossing direction.

U.S. Pat. No. 5,068,537 describes another system for counting moving living beings using a large number of cells placed over a single line. The system is designed such that an average-sized living being is detected by at least two cells. Since each cell comprises only one detector, the system does not allow the crossing direction of the living beings counted to be determined.

In the system for counting living beings which is the subject of the invention, the thermal radiation detectors used are thermopiles which are characterized by their ability to detect even very slow temperature variations in their field of vision. The system for counting living beings, which is the subject of the invention, consists of a set of N thermal radiation detection cells and an electronic device for acquiring and processing signals delivered by these cells. Each of these cells especially comprises a thermopile comprising at least one sensitive element, a means focusing the thermal radiation onto the sensitive elements of this thermopile, this focusing means creating an elongate field of vision in one direction, a mask limiting this field of vision and an amplifier for amplifying the signal delivered by the thermopile. In the system for counting living beings, which is the subject of the invention, the N detection cells are equally distributed between two curves when N is even and are distributed between two curves with a difference of one when N is odd, the distribution of cells over each curve being uniform along a pitch P which is identical for each of the two curves, one of these curves being identified with the directrix of the cylindrical surface through which the living beings pass, and the other curve being distant from the former one by a length D equal to at least 5 cm, the elongation direction of the field of vision of each cell being substantially tangent to one of the two curves.

Generally, a filter placed in the thermopile in front of the sensitive element limits the sensitivity to thermal radiation of bodies with a temperature close to the ambient temperature, which corresponds to far infrared radiation in the wavelength band from about 7 to 14 μm. The means for focusing each cell is adapted to the number, the arrangement and the geometry of the sensitive element or elements of the thermopile so as to create a field of vision elongated in one direction and as narrow as possible in the direction perpendicular to the previous direction. The focusing means is produced in a preferred manner by means of one or more lenses. It may possibly be produced by a pinhole or by a mirror. According to the invention, a single lens is used, preferably when the thermopile comprises a single sensitive element with an elongate surface or an alignment of sensitive elements, the surfaces of which have substantially similar dimensions in two orthogonal directions. According to the invention, several lenses are used, preferably when the thermopile comprises only a single sensitive element, the surface of which has substantially similar dimensions in two orthogonal directions.

In the systems which are the subject of the invention, it is wise to choose a pitch P for distributing the detection cells which is close to the width of a living being statistically representative of beings of minimum size belonging to the population to be counted. When it involves counting human beings, this pitch P is substantially equal to 45 cm.

More particularly, the system which is the subject of the invention is used to count living being crossing a plane; in this case, the curves over which the cells are distributed are parallel straight lines.

The aperture of the field of vision, in the elongation direction of this field, is chosen for each cell belonging to the same straight line, so as to juxtapose zones seen by two successive cells on the same straight line, at a height close to the minimum size of a living being statistically representative of beings belonging to the population to be counted.

Furthermore, when it involves counting human beings crossing a plane, it is appropriate to design the system which is the subject of the invention such that the extent of the zone seen by each cell at a height of 1 m and measured along the alignment is substantially equal to 45 cm.

The system for counting living beings which is the subject of the invention comprises an electronic device for processing signals delivered by the cells which exploits an algorithm. A first task of this algorithm initializes the parameters specifying the configuration of the system. The second task of this algorithm reads and processes the digital values delivered by the electronic acquisition device successively for each cell. A third task of this algorithm adapts the cell sensitivity threshold. A fourth task of this algorithm analyzes the information from the second task for all the successive pairs of cells. A fifth task of this algorithm analyzes the results of the fourth task and deduces therefrom the count of living beings, their direction crossing and their speed of movement. A sixth task of this algorithm exploits the counts thus obtained as a function of the envisaged application. A seventh task of this algorithm manages the rate of execution of the previous tasks depending on the frequency of sampling of the signals delivered by the cells. In the systems for counting living beings which are the subject of the invention, it is possible to design the fifth task of the algorithm so as to allow the bringing together, in the form of entities, of pairs of successive cells for which the information from the fourth task of the algorithm corresponds to the crossing of a living being or of a group of living beings, the information of the pairs of each entity specifying this number of living beings, the direction of their crossing and the speed of their movement.

The system for counting living beings which is the subject of the invention offers various advantages with respect to the known systems and especially its easy integration for any width of passage to be monitored; its excellent counting performance even for a small passage height; its suitability for implanting in particular environments; its ability to count dense crowds and slowly moving living beings.

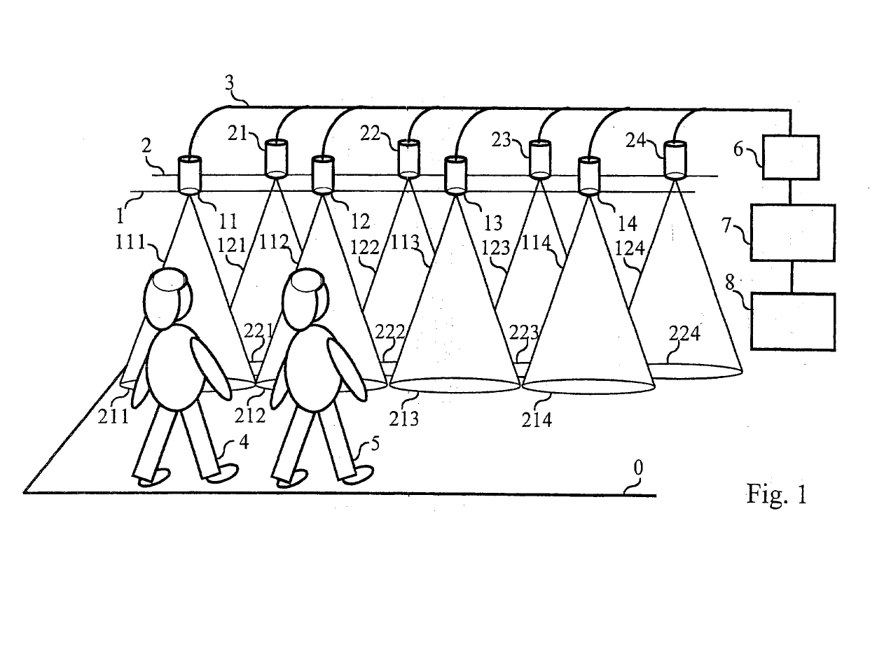

The system for counting living beings which is the subject of the invention may be described by way of nonlimiting example by means of the following example illustrated by FIGS. 1 to 14. This example corresponds to the counting of human beings crossing a plane, by means of eight cells equally distributed over two straight lines.

FIG. 1 shows schematically a system which is the subject of the invention comprising eight cells placed in two alignments.

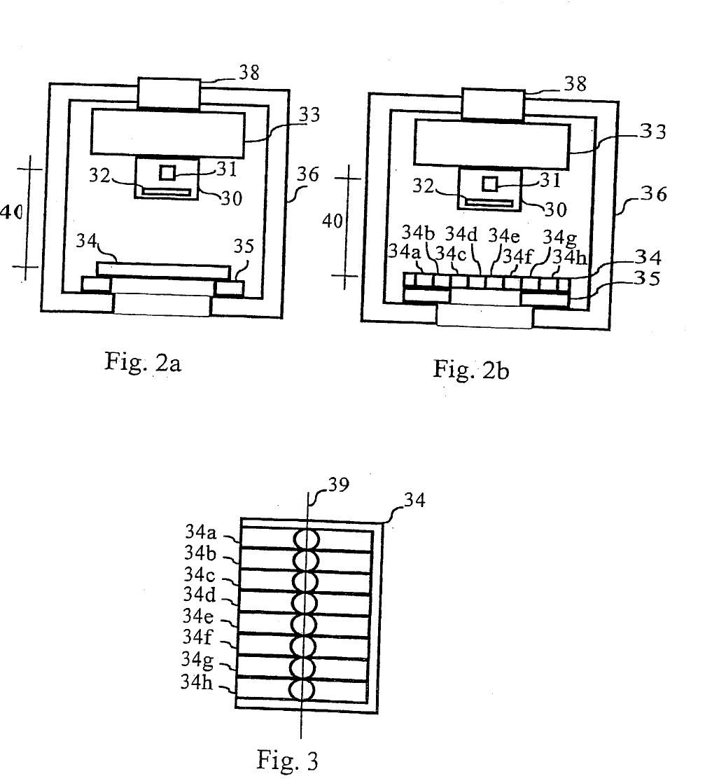

FIGS. 2a and 2b show two views of a thermal radiation detection cell used in the system shown diagrammatically in FIG. 1.

FIG. 3 shows an array of Fresnel lenses used in the cell shown in FIGS. 2a and 2b.

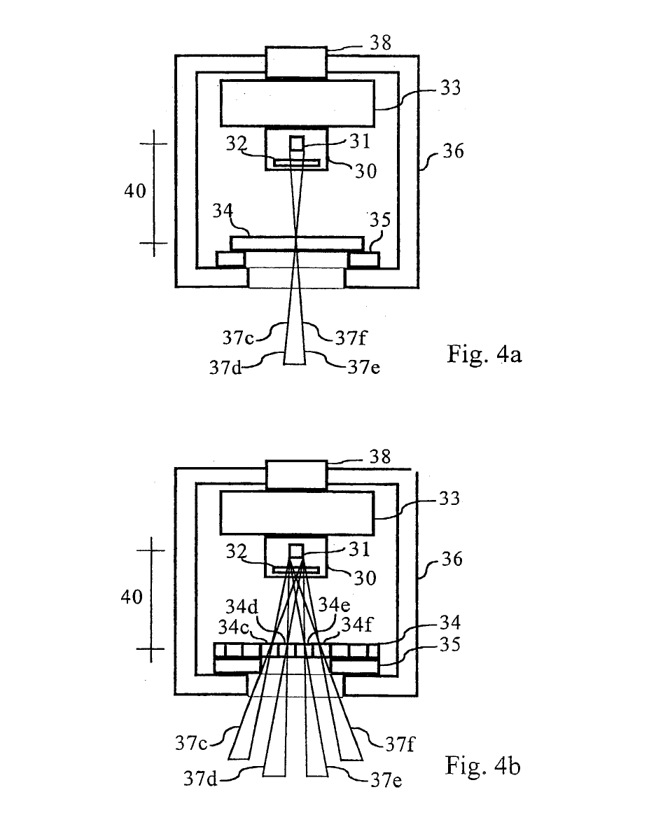

FIGS. 4a and 4b represent the cell shown in FIGS. 2a and 2b with its field of vision.

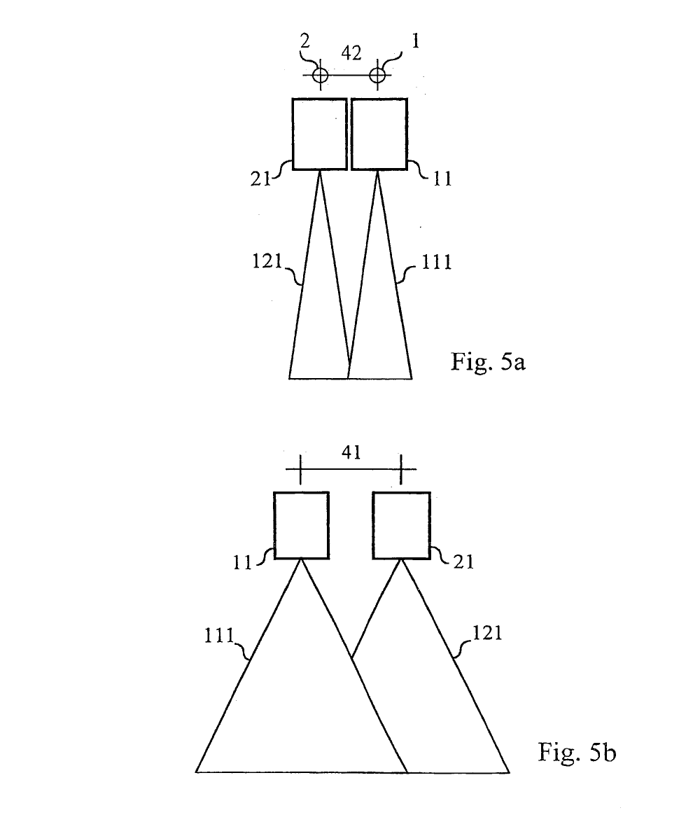

FIGS. 5a and 5b show two views, in two orthogonal directions, of a group of two successive cells, each of them belonging to a different alignment, together with the fields of vision of these cells.

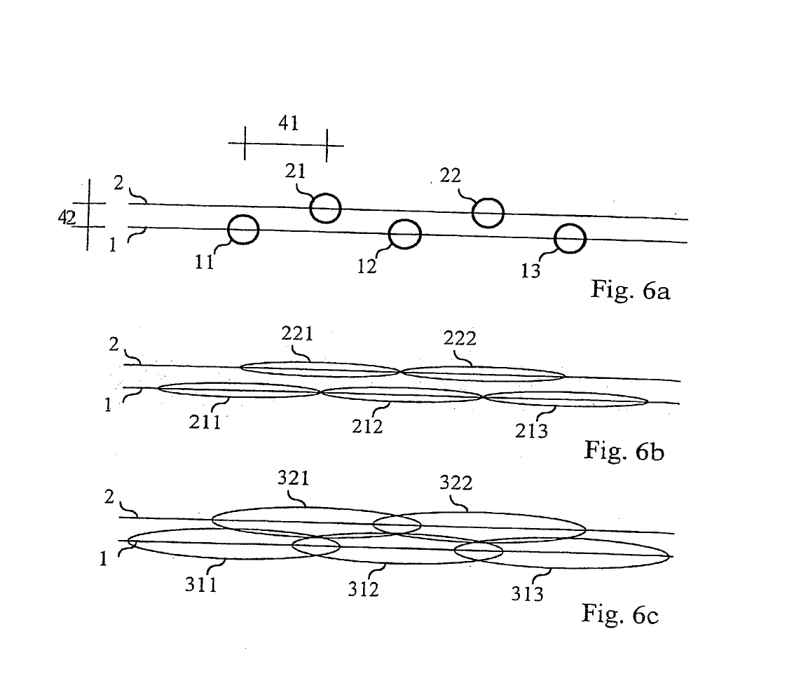

FIG. 6a shows, in top view, five successive cells belonging to the system shown in FIG. 1.

FIGS. 6b and 6c show, in top view, the zones seen by the five cells shown diagrammatically in FIG. 6a, at the height of 1 m and at ground level, respectively.

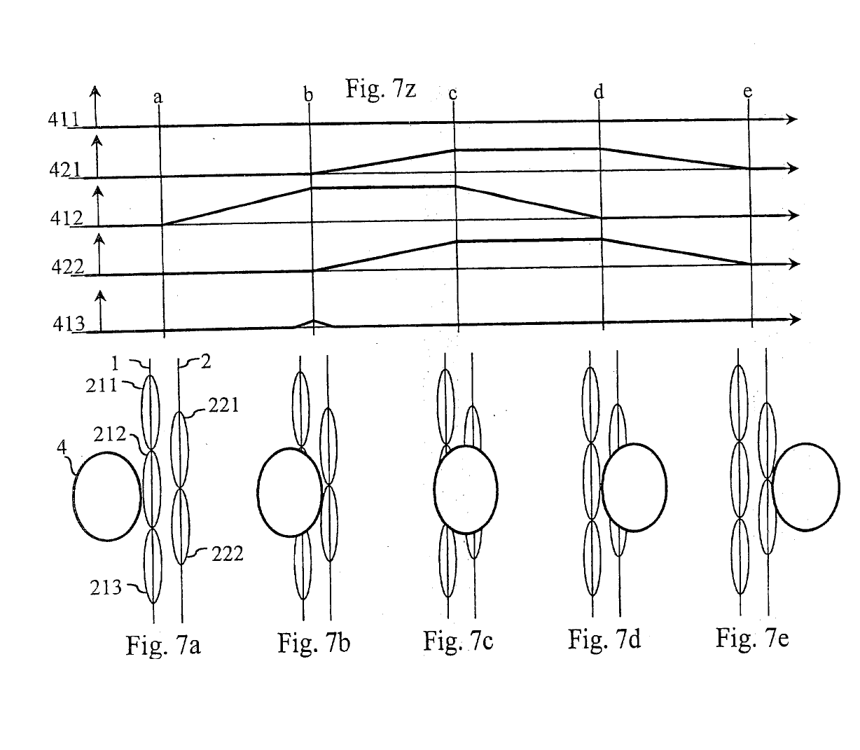

FIGS. 7a to 7e show, in top view, five successive phases of a human being crossing perpendicularly to the alignment of the cells and for a representation of the zones seen in FIG. 6b.

FIG. 7z shows schematically the change with time of the signals delivered by the thermopile of each cell, for the crossing defined by FIGS. 7a to 7e.

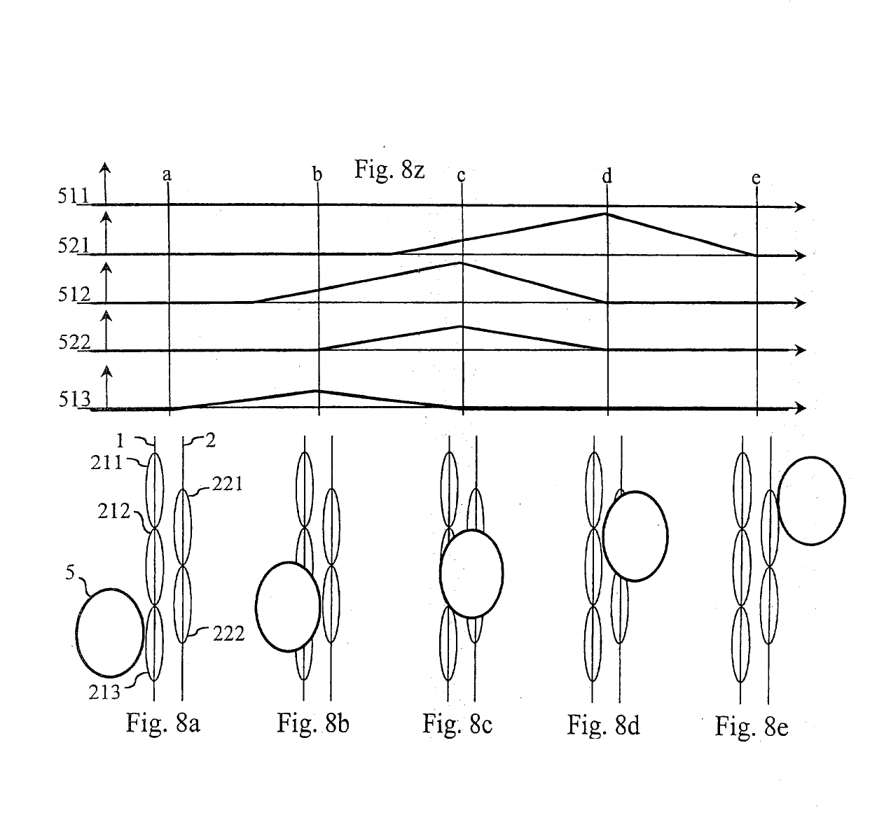

FIGS. 8a to 8e show, in top view, five successive phases of a human being crossing obliquely to the alignment of the cells and for a representation of the zones seen in FIG. 6b.

FIG. 8z schematically shows the change with time of the signals delivered by the thermopile of each cell, for the crossing defined by FIGS. 8a to 8e.

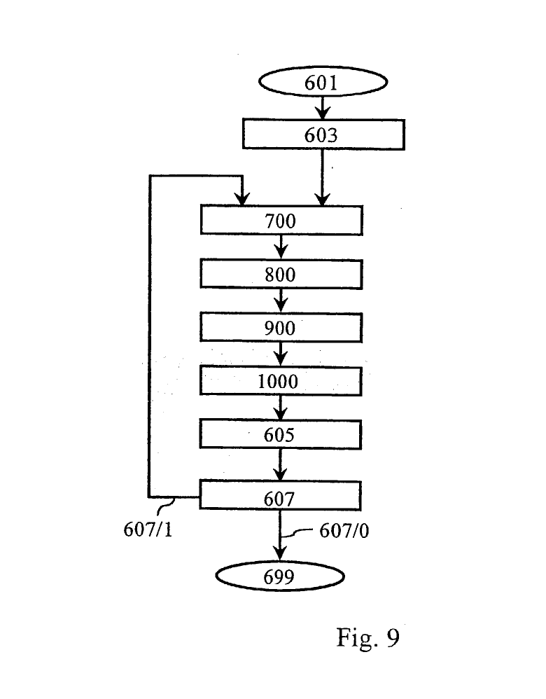

FIG. 9 shows the chronological sequence, in the form of a flowchart, of the various tasks for processing the electrical signals, delivered by the cells.

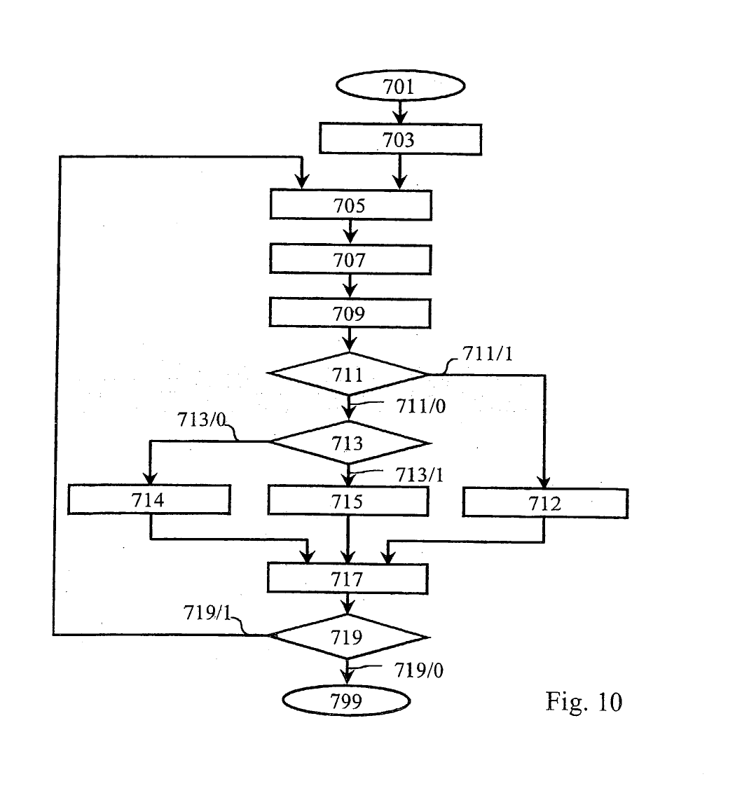

FIGS. 10, 11, 12 and 13 show four particular tasks of the flowchart shown in FIG. 9.

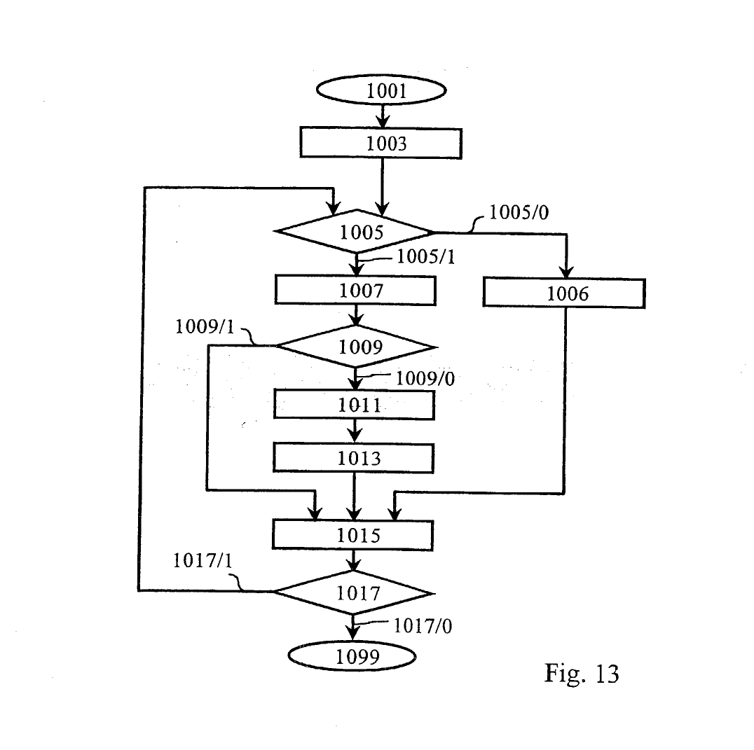

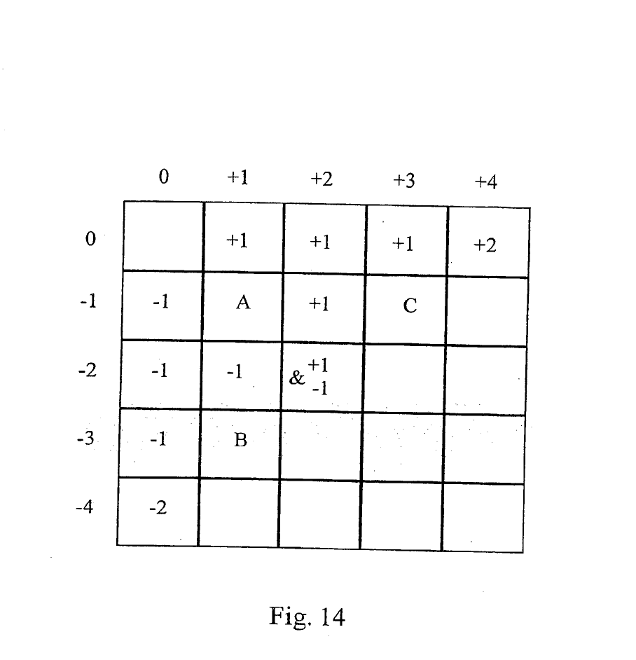

FIG. 14 shows the table used by the particular task shown in FIG. 13.

FIG. 1 shows the ground 0, a set of eight thermal radiation detection cells distributed in two alignments, a first alignment 1 comprising four cells 11; 12; 13; 14, a second alignment 2 comprising four cells 21; 22; 23; 24, two human beings 4 and 5, an electronic device 6 for acquiring and digitizing the signals delivered by the cells, these signals possibly being sampled at the cells, an electronic device 7 for processing the digital values delivered by the acquisition device 6, a device 8 for exploiting the information from the processing device 7, and a medium 3 connecting all the cells to the acquisition device 6. The eight cones 111 to 114 and 121 to 124 show diagrammatically the fields of vision of each of the cells. The intersections of these cones with a plane parallel to the ground 0 and located at a height of 1 m define the zones seen at this height and are shown diagrammatically by the eight ellipses 211 to 214 and 221 to 224.

FIG. 2a is a diagrammatic section of a cell through a plane perpendicular to the two alignments of the cells. FIG. 2b is a diagrammatic section of the same cell, orthogonal to the section shown in FIG. 2a.

This cell comprises a thermopile 30, the sensitive element 31 of which provides a low-amplitude electrical signal proportional to the thermal radiation received through the infrared filter 32, a stage 33 for amplifying and shaping the electrical signal delivered by the thermopile 30, a device 38 connecting the amplification and shaping stage 33 to the medium 3, an array of Fresnel lenses 34 of focal length 40, placed at a distance equal to this focal length 40 in front of the sensitive element 31 of the thermopile 30, a mask 35 placed in front of the array of Fresnel lenses 34 and a light-tight box 36, opaque to electromagnetic radiation and whose inner surface absorbs thermal radiation. The array of Fresnel lenses 34 has eight elements 34a to 34h.

FIG. 3 shows the array of Fresnel lenses 34. This array consists of eight elementary Fresnel lenses 34a to 34h. These lenses are juxtaposed and their optical centers are aligned along the straight line 39.

FIGS. 4a and 4b represent the cell shown in FIGS. 2a and 2b along the same projections. These figures show the elementary fields of vision 37c, 37d, 37e and 37f associated with the nonmasked elementary Fresnel lenses 34c, 34d, 34e and 34f.

FIGS. 5a and 5b show successive cells 11 and 21 together with their respective fields of vision 111 and 121. These two cells belong to a different alignment. FIG. 5a shows the fields of vision perpendicular to the normal direction of movement of human beings. FIG. 5b shows the fields of vision in the normal direction of movement of human beings.

The view shown in FIG. 5a highlights the small aperture of the fields of vision 111 and 121 together with the short distance D 42 between the two alignments 1 and 2.

The view shown in FIG. 5b highlights the large aperture of the fields of vision 111 and 121 together with the half-pitch P/2 41 between these cells.

FIG. 6a shows a top view of five cells 11; 21; 12; 22; 13 placed along two alignments 1 and 2 and separated by the distance D 42. This view also shows the half-pitch P/2 41 between two successive cells.

FIG. 6b shows a top view of the arrangement of zones 211; 221; 212; 222; 213 seen at a height of 1 m above ground level 0 and corresponding respectively to the cells 11; 21; 12; 22; 13. This FIG. 6b highlights the juxtaposition of the zones seen by two successive cells placed in the same alignment.

FIG. 6c shows, in top view, the arrangement of the zones seen at ground level 0, 311; 321; 312; 322; 313 corresponding, respectively, to the cells 11; 21; 12; 22; 13. This FIG. 6c highlights the partial superposition of the zones seen by two successive cells arranged in the same alignment.

FIGS. 7a to 7e show, respectively, in top view five successive phases a, b, c, d, e of a human being 4 crossing perpendicularly to the alignments 1 and 2, together with the zones seen at a height of 1 m above ground level, shown in FIG. 6b. FIG. 7z shows diagrammatically the oscillograms of the electrical signals 411; 421; 412; 422; 413 delivered respectively by the cells 11; 21; 12; 22; 13. The level of each electrical signal 411; 421; 412; 422; 413 is associated with the portion of the seen zone occupied by the human being crossing the fields of vision of the cells 11; 21; 12; 22; 13.

In phase a, the human being 4 is not present in any of the seen zones 211; 221; 212; 222; 213. The electrical signals 411; 421; 412; 422; 413 shown in FIG. 7z have a zero level.

In phase b, the human being 4 completely occupies the seen zone 212. The level of the signal 412 is a maximum. The human being 4 occupies the seen zone 213 to a very slight extent. The level of the signal 413 has a very low amplitude peak. The seen zones 211; 221; 222 are not occupied by the human being 4. The levels of the corresponding signals 411; 421; 422 remain zero. In phase c, the human being 4 continues to completely occupy the seen zone 212. The level of the signal 412 remains a maximum. The human being 4 partially occupies the seen zones 221 and 222. The level of the signals 421 and 422 is medium. The seen zones 211 and 213 are not occupied by the human being 4. The levels of the corresponding signals 411 and 413 remain zero.

In phase d, the human being 4 leaves the seen zone 212. The level of the signal 412 becomes zero again. The human being 4 continues to partially occupy the seen zones 221 and 222. The level of signals 421 and 422 remains medium. The seen zones 211 and 213 are not occupied by the human being 4. The levels of the corresponding signal 411 and 413 remain zero.

In phase e, the human being 4 leaves the seen zones 221 and 222. The level of the signals 421 and 422 becomes zero again. The seen zones 211; 212; 213 are not occupied by the human being 4. The levels of the corresponding signals 411, 412; 413 remain zero.

Since all the signal levels are zero, it will be possible for the human being 4 to be counted with discrimination in the direction crossing the alignments.

FIGS. 8a to 8e show respectively, in top view, five successive phases a, b, c, d, e of a human being 5 crossing obliquely to the alignments 1 and 2, together with the seen zones at a height of 1 m above ground level, shown in FIG. 6b. FIG. 8z shows diagrammatically the oscillograms of the electrical signals 511; 521; 512; 522; 513 delivered respectively by the cells 11; 21; 12; 22; 13. The level of each electrical signal 511; 521; 512; 522; 513 is associated with the portion of the seen zone occupied by the human being crossing the fields of vision of the cells 11; 21; 12; 22; 13.

In phase a, the human being 5 is not present in any of the seen zones 211; 221; 212; 222; 213. The electrical signals 511; 521; 512; 522; 513 shown in FIG. 8z have a zero level.

In phase b, the human being 5 partially occupies the seen zones 212 and 213. The level of the signals 512 and 513 is medium. The seen zones 211; 221; 222 are not occupied by the human being 5. The levels of the corresponding signals 511; 521; 522 are zero.

In phase c, the human being 5 occupies virtually the entire seen zone 212. The level of the signal 512 reaches a maximum. The human being 5 partially occupies the seen zones 221 and 222. The level of the signals 521 and 522 is medium. The seen zones 211 and 213 are not occupied by the human being 5. The levels of the corresponding signals 511 and 513 remain zero.

In phase d, the human being 5 leaves the seen zones 212 and 222. The level of the signals 512 and 522 become zero again. The human being 5 completely occupies the seen zones 221. The level of the signal 521 reaches a maximum. The seen zones 211 and 213 are not occupied by the human being 5. The levels of the corresponding signals 511 and 513 remain zero.

In phase e, the human being 5 leaves the seen zone 221. The level of the signal 521 becomes zero again. The seen zones 211; 212; 213; 222 are not occupied by the human being 5. The levels of the corresponding signals 511; 512; 513; 522 remain zero.

Since all the signal levels are zero, it will be possible for the human being 5 to be counted with discrimination in the direction crossing the alignments.

FIG. 9 shows the chronological sequence, in the form of a flowchart, of the various real time tasks for processing digital values from an electronic device 6 for acquiring and digitizing electrical signals 411; 421; 412; 422; 413, delivered by the five cells 11; 21; 12; 22; 13. This flowchart is implemented by the electronic device 7. The flowchart of FIG. 9 has an input point 601 and an output point 699. It comprises seven tasks 603; 700; 800; 900; 1000; 605; 607.

Task 603 allows the parameters specifying the configuration of the counting system to be initialized: number of cells, cell height with respect to the ground, pitch P and distance D as well as the processing parameters: frequency of sampling of the electrical signals delivered by the cells and initial cell sensitivity threshold. Task 603 positions the cells in the state stored as INVALID together with the pairs of successive cells, that is to say the pairs such as the pair 11;21 followed by pair 21;12, itself followed by the pair 12;22 and so on and so forth, in the state stored as INVALID.

Task 700 successively reads and processes the digital values delivered by the electronic device 6, for each cell.

Task 800 matches the cell sensitivity threshold, used by task 700, for the system which is the subject of the invention.

Task 900 analyzes the information from task 700 for all the successive pairs of cells.

Task 1000 analyzes the results of task 900 and deduces the number of human beings therefrom.

Task 605 allows the exploitation of the count produced by task 1000, by the electronic device 8, as a function of the envisioned application.

Task 607 manages the rate of executing tasks 700 to 605 according to the sampling frequency; this task 607 is executed at each time (t). For this purpose, task 607 sets the timing of the branching 607/1 toward task 700.

Task 607 also makes it possible to finally quit executing tasks 700 to 605 via the branch 607/0 toward the output point 699.

To execute tasks 700, 800, 900 and 1000, an index k is associated with each cell. The value 1 of the index k is associated with an extreme cell, 11 for example; the value 2 of the index k is associated with the successive cell, in this case, the cell 21, and so on and so forth. Similarly, an index m is associated with each pair of successive cells. The value 1 of the index m is associated with an extreme pair, 11;21 for example; the value 2 of the index m is associated with the successive pair, in this case the pair 21;12, and so on and so forth.

FIGS. 10, 11, 12 and 13 show respectively, in the form of flowcharts, the chronological sequence of the elementary tasks forming tasks 700; 800; 900 and 1000.

In FIG. 10, the input point 701 and the output point 799 of task 700 are seen. This tasks repeats elementary tasks 705 to 719 for each digital value delivered by the electronic device 6.

Task 703 initializes to 1 the index k associated with the cell which is being read and whose digital value is being processed.

Task 705 controls the acquisition and digitization by the electronic device 6 of the electrical signal delivered at time (t) by the cell in question.

Task 707 processes the digital value delivered by task 705 for the purpose of homogenizing the set of digital values of the delivered signals.

Task 709 stores the value processed by task 707 if it corresponds to a local maximum, determined from values processed beforehand by task 707 for this cell. The value stored by task 709 is used for adapting the cell sensitivity threshold in task 800.

Test 711 checks that the value processed by task 707 is greater than the cell sensitivity threshold.

The branch 711/1 is effective if test 711 is TRUE; in this case, a human being is in the field of vision of the cell in question.

Task 712 stores the value processed by task 707 and time (t); it positions the cell in question in the instantaneous ACTIVE state.

The branch 711/0 is effective if test 711 is FALSE.

Test 713 checks that the value processed by task 707 is greater than the cell sensitivity threshold, at the previous time (t−1).

The branch 713/1 is effective if test 713 is TRUE; in this case, a human being has just left the field of vision of the cell in question; task 715 analyzes the successive values stored by task 712 in order to extract from them information characteristic of a human being crossing: time at which the crossing starts, time at which the crossing ends, time corresponding to the median of the stored values and mean of these values; it positions the cell in question in the stored VALID state. All this information is stored in order to be analyzed by task 900.

The branch 713/0 is effective if test 713 is FALSE; in this case, no human being is in the field of vision of the cell in question.

Task 714 positions the cell in question in the instantaneous PASSIVE state.

Task 717 increments the index k associated with a cell.

Test 719 checks that the new index k is less than or equal to the total number of cells.

The branch 719/1 is effective if test 719 is TRUE; in this case, all the cells have not been processed and task 705 is returned to.

The branch 719/0 is effective if test 719 is FALSE; in this case, all the cells have been processed.

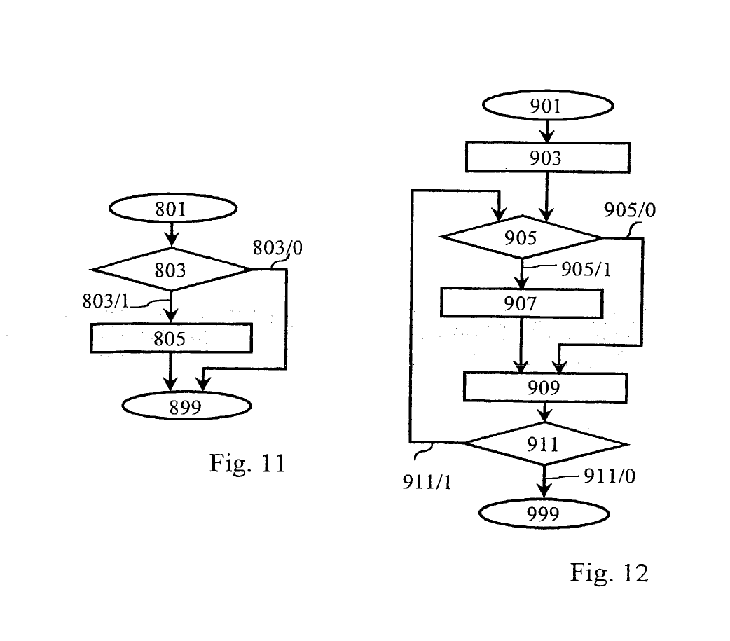

In FIG. 11, the input point 801 and the output point 899 of task 800 are seen.

This task comprises two elementary tasks 803 and 805 for adapting the cell sensitivity threshold as a function of the V last values stored by task 709 of FIG. 10; V being chosen arbitrarily as a function of the application, for example as a function of the frequency of crossing by human beings or as a function of a fixed number of crossings; this number may be chosen from the range going from 20 to 100.

Test 803 checks that all the cells are in the instantaneous PASSIVE state and that at least V values have been stored by task 709 from task 700.

The branch 803/1 is effective if test 803 is TRUE; in this case, the cell sensitivity threshold can be adapted.

Task 805 calculates the sliding average over the set of V last values stored by task 709 of FIG. 10 and deduces the new cell sensitivity threshold therefrom.

The branch 803/0 is effective if test 803 is FALSE; in this case, the cell sensitivity threshold cannot be adapted.

In FIG. 12, the input point 901 and the output point 999 of task 900 are seen. This task repeats elementary tasks 905 to 911 for each cell pair. It analyzes the characteristic information extracted for each cell by task 700 and deduces the information characteristic of each pair therefrom.

Task 903 initializes to 1 the index m associated with the cell pair to be analyzed.

Test 905 checks that the two cells forming the pair in question are in the stored VALID state and that there is a period of common occupation during which the human being is simultaneously in the field of vision of both cells, which amounts to considering that the human being is in the field of vision of the pair.

The branch 905/1 is effective if test 905 is TRUE.

Task 907 analyzes the characteristic information extracted for each cell of the pair of successive cells in question and deduces therefrom the characteristic information of the crossing of a human being for this pair: time at which common occupation starts, time at which common occupation ends, pair mean, that is to say mean of the means calculated for the cells of the pair, sign of the chronology of occupation of the cells of the pair; the state of the pair of successive cells is considered as VALID. The sign of the chronology of occupation of the cells of the pair is chosen arbitrarily as POSITIVE if the human being crosses alignment 1 then alignment 2 and NEGATIVE if the human being crosses alignment 2 then alignment 1.

The branch 905/0 is effective if test 905 is FALSE.

Task 909 increments the index m associated with a pair.

Test 911 verifies that the new index m is less than or equal to the total number of pairs.

The branch 911/1 is effective if test 911 is TRUE; in this case, not all the pairs have been analyzed and test 905 is returned to.

The branch 911/0 is effective if test 911 is FALSE; in this case, all the pairs have been analyzed.

In FIG. 13, the input point 1001 and the output point 1099 of task 1000 can be seen. This task repeats elementary tasks 1005 to 1017 for each cell pair so as to analyze the characteristic information extracted for each pair during task 900 together with the characteristic information extracted for each cell during task 700. This analysis makes it possible to construct entities consisting either of an isolated pair whose state is VALID, or of successive pairs whose state is VALID and for which there is a period of time during which one or more human beings are simultaneously in their field of vision. More specifically, an entity is characterized by a number X of pairs whose sign of the chronology of occupation is POSITIVE together with a number Y of pairs whose sign of the chronology of occupation is NEGATIVE. Analysis of these characteristic numbers of the entity makes it possible to determine in real time the number of human beings associated with this entity together with their direction of crossing, according to a rule specified in FIG. 14.

Task 1003 initializes to 1 the index m associated with the pair of cells to be analyzed and initializes to zero the contents of the entity, which means that the entity does not contain a pair.

Test 1005 checks that the pair in question is in the VALID state.

The branch 1005/0 is effective if test 1005 is FALSE.

Task 1006 reinitializes to zero the content of the entity, which means that the entity does not contain any pair.

The branch 1005/1 is effective if test 1005 is TRUE.

Task 1007 includes the pair in question in the entity.

Test 1009 checks that there is a period of time during which one or more human beings are in the field of vision of the pair in question and of the following pair.

The branch 1009/0 is effective if test 1009 is FALSE; in this case, the entity is complete, it can be analyzed in order to count the human beings.

Task 1011 uses the table shown in FIG. 14 in order to analyze the entity and determine in real time the number of human beings and their direction of crossing.

Task 1013 updates the characteristic information of the pairs and of the cells contained in the entity then reinitializes the content of the entity to 0. The state of these pairs and the stored state of these cells are repositioned to the INVALID state.

Branch 1009/1 is effective if test 1009 is TRUE; in this case, the following pair is likely to be included in the entity.

Task 1015 increments the index m associated with a pair.

Test 1017 checks that the new index m is less than or equal to the total number of pairs.

The branch 1017/1 is effective if test 1017 is TRUE; in this case, not all the pairs have been analyzed and test 1005 is returned to.

The branch 1017/0 is effective if test 1017 is FALSE; in this case, all the pairs have been analyzed.

FIG. 14 shows the table for analyzing characteristic numbers of the entity created during task 1000. This table has as many columns and rows as there are cells in the system. This table defines the number of human beings associated with the entity together with their direction of crossing as a function of the characteristic numbers of the entity. The numbers of the columns correspond to the possible values taken by the number X and the numbers of the rows correspond to the possible values taken by the number Y. The empty boxes of the table correspond to impossible situations; the other boxes of the table comprise either a letter, or at least one signed integer, whose modulus represents the number of human beings counted and whose sign corresponds to the initial crossing of the alignment 1 if it is positive and to the initial crossing of the alignment 2 if it is negative.

The letters A, B and C of the table correspond to the particular cases for which the counting of human beings is conditioned by additional information.

The letter A is to be replaced by (+1) when the mean of the pair having the POSITIVE sign is greater than the mean of the pair having the NEGATIVE sign.

The letter A is to be replaced by (−1) when the mean of the pair having the POSITIVE sign is less than the mean of the pair having the NEGATIVE sign.

The letter B is to be replaced by the set (+1) & (−1) when the pair having the POSITIVE sign has been included in the entity before or after the other pairs and by (−2) in the other cases.

The letter C is to be replaced by the set (+1) & (−1) when the pair having the NEGATIVE sign has been included in the entity before or after the other pairs and by (+2) in the other cases.

1. A system for counting living beings moving on a first surface (0) and passing through a second cylindrical surface with a substantially vertical generatrix, consisting of a set of N thermal radiation detection cells (11) and an electronic device for acquiring and processing signals delivered by these cells, characterized in that each of these cells especially comprises a thermopile (30) comprising at least one sensitive element (31), a means (34) focusing the thermal radiation on the sensitive elements of this thermopile, this focusing means creating an elongate field of vision (111) in one direction, a mask (35) limiting this field of vision and an amplifier for amplifying the signal delivered by the thermopile (30) and characterized in that the N detection cells (11) are equally distributed between two curves when N is even and are distributed between two curves with a difference of one when N is odd, the distribution of cells over each curve being uniform along a pitch P which is identical for each of the two curves, one of these curves being identified with the directrix of the cylindrical surface through which the living beings pass, and the other curve being distant from the former one by a length D (42) equal to at least 5 cm, the elongation direction of the field of vision of each cell being substantially tangent to one of the two curves.

2. The system for counting living beings as claimed in claim 1, characterized in that the means (34) of focusing each cell is produced with a single lens and in that the thermopile comprises a single sensitive element with an elongate surface or an alignment of sensitive elements, the surfaces of which have substantially similar dimensions in two orthogonal directions.

3. The system for counting living beings as claimed in claim 1, characterized in that the means (34) of focusing each cell is produced using several lenses and in that the thermopile comprises only a single sensitive element, the surface of which has substantially similar dimensions in two orthogonal directions.

4. The system for counting living beings as claimed in claim 1, characterized in that the pitch P is chosen close to the width of a living being statistically representative of beings of minimum size belonging to the population to be counted.

5. The system for counting living beings as claimed in claim 4, characterized in that the living beings are human beings and in that the pitch P is substantially equal to 45 cm.

6. The system for counting living beings as claimed in claim 1, characterized in that the cylindrical surface through which the living beings pass is a plane, the curves along which the cells are distributed being parallel straight lines.

7. The system for counting living beings as claimed in claim 6, characterized in that the aperture of the field of vision (111), in the elongation direction of this field, is chosen for each cell belonging to the same straight line, so as to juxtapose zones (211) (212) seen by two successive cells (11) (12) on the same straight line (1), at a height close to the minimum size of a living being statistically representative of beings belonging to the population to be counted.

8. The system for counting living beings as claimed in claim 7, characterized in that the living beings are human beings and in that the extent of the zone seen by each cell at a height of 1 m and measured along the alignment is substantially equal to 45 cm.

9. The system for counting living beings as claimed in claim 1, characterized in that the electronic device (7) for processing signals delivered by the cells exploits an algorithm, a first task (603) of which initializes the parameters specifying the configuration of the system, a second task (700) of which reads and processes the digital values delivered by the electronic acquisition device successively for each cell, a third task (800) of which adapts the cell sensitivity threshold, a fourth task (900) of which compares the information from the second task (700) for all the pairs of successive cells, a fifth task (1000) of which analyzes the results of the fourth task (900) and deduces therefrom the count of living beings, their direction of crossing and their speed of movement, a sixth task (605) of which exploits the count thus obtained as a function of the envisioned application and a seventh task (607) of which manages the rate of execution of the previous tasks depending on the frequency of sampling of the signals delivered by the cells.

10. The system for counting living beings as claimed in claim 9, characterized in that the analysis carried out by the fifth task (1000) of the algorithm brings together, in the form of entities, pairs of successive cells for which the information from the fourth task (900) corresponds to the crossing of a living being or of a group of living beings, the information of the pairs of each entity specifying this number of living beings, the direction of their crossing and the speed of their movement.
